(19) United States
(12) Patent Application Publication
(10) Pub. No.: US 2013/0013429 A1
(43) Pub. Date: Jan. 10, 2013

(54) SYSTEMS, METHODS, AND MEDIA FOR PROVIDING ADVERTISEMENTS BASED UPON RELATIONAL DATA

(76) Inventors: Daniel Allan Mooney, Tulsa, OK (US); Shaun Duncan Charles Edwardes, Tulsa, OK (US)

(21) Appl. No.: 13/544,989

(22) Filed: Jul. 9, 2012

Related U.S. Application Data
(60) Provisional application No. 61/505,113, filed on Jul. 7, 2011.

(51) Int. Cl. G06Q 30/02; G06F 17/30

(52) U.S. Cl. 705/14.73; 707/769; 707/E17.014

(57) ABSTRACT

Systems, method, and media for providing advertisements based upon relational data are provided herein. According to some embodiments, method for processing queries may include the steps of receiving query via a web server, from a client device, generating, via the web server, a response for the query by determining a header object in the query, determining connected entities in a database for the header object, and assembling the connected entities together into the response according to a long-tail response format.

### CROSS REFERENCE TO RELATED APPLICATION

This Non-Provisional U.S. Patent Application claims priority to Provisional U.S. Patent Application 61/505,113, filed on Jul. 7, 2011, entitled “SYSTEMS, METHODS, AND MEDIA FOR PROVIDING ADVERTISEMENTS BASED UPON RELATIONAL DATA” which is hereby incorporated by reference herein in its entirety.

### FIELD OF THE INVENTION

This invention relates generally to providing of advertisements, and more particularly, but not by way of limitation, to systems, methods, and media that provide advertisements based upon relational data.

### BACKGROUND

The provision of advertisements is well known in within the online media arts. While the provision of advertisements is well known, the systems and methods that provide these advertisements often utilize randomized advertising. Additionally, while the personalization of advertisements may alleviate some of the drawbacks of randomized advertising schemas, static advertising content (even when personalized) may become stagnant and ineffective.

Additionally, while advertisements may be personalized, such personalized advertisements depend upon data that directly correlates the advertisement to the customer. For example, if the advertiser knows that the customer enjoys a particular artist, the advertiser may provide specific advertisements that are associated with product or services offered by the artist.

Unfortunately, these types of direct correlation advertisements cannot suggest valuable, yet non-intuitive products or services to the customer. Similarly, none of these systems or methods provide current advertisements based upon the presentation of legacy advertisements, nor do they facilitate the use of dynamically presented advertising schemas that selectively rotate advertisements to substantially reduce end user advertising fatigue.

### SUMMARY OF THE INVENTION

According to some embodiments, the present technology may be directed to methods for processing a query that comprises the steps of: (a) receiving query via a web server, from a client device; (b) generating, via the web server, a response for the query by: (i) determining a header object in the query; (ii) determining connected entities in a database for the header object; and (iii) assembling the connected entities together into the response according to a long-tail response format; and (c) returning the response to the client device.

According to additional embodiments, the present technology may be directed to methods providing advertisements based upon relational data that comprises the steps of: (a) receiving query via a web server, from a client device; (b) generating, via the web server, a response for the query by: (i) determining a header object in the query; (ii) locating a first advertisement associated with the header object; and (iii) locating a legacy advertisement if the first advertisement is a current advertisement or a current advertisement if the first advertisement is a legacy advertisement; and (c) returning the response to the client device.

According to exemplary embodiments, the present technology may be directed to a system for processing a query that comprises: (a) at least one server that is selectively coupleable to a client device, the at least one server comprising a processor configured to execute instructions that comprise: (i) a query module that receives query from a client device; and (ii) an analysis module that generates a response for the query by: (1) determining a header object in the query; (2) determining connected entities in a database for the header object; assembling the connected entities together into the response according to a long-tail response format; and (3) returning the response to the client device.

### BRIEF DESCRIPTION OF THE DRAWINGS

FIG. 1 is an architectural diagram of an exemplary system for practicing the present technology.

FIG. 2 is an exemplary relational analysis system, constructed in accordance with the present technology.

FIG. 3 is a flowchart of an exemplary method for providing a current advertisement based upon the provision of a legacy advertisement.

FIG. 4A is a flowchart of an exemplary method for providing advertisements based upon relational data.

FIG. 4B is flowchart of another exemplary method for providing selective advertisements based upon relational data

FIG. 5 is an architectural diagram of an exemplary computing system for practicing the present technology.

### DETAILED DESCRIPTION OF EXEMPLARY EMBODIMENTS

According to some embodiments, the present technology may be directed to the provision of advertisements based upon relational data. In other embodiments, the present technology may be directed to the provision of current advertisements based upon the provision of a legacy advertisement (or vice versa), thereby enhancing the generation of advertising revenue by legacy advertisements. In some applications, the legacy advertisements may be displayed within the context of a graphical display of relational data.

It will be understood that “legacy advertisements” may include advertisements that are no longer being actively or currently utilized by the advertising entity (e.g., marketers, company, etc.). These legacy advertisements may include any of videos, audio, images, documents, and combinations thereof, along with any other types of advertisements that would be known to one of ordinary skill in the art with the present disclosure before them. These types of legacy advertisements are often older and less relevant to the advertiser than current advertisements. For example, a legacy advertisement may include an endorsement from an artist who is not longer relevant. While legacy advertisements may be older and/or less relevant to the advertiser, these legacy advertisements may be of interests to customers or other viewers who are interested in brand development, brand evolution, or brand nostalgia—just to name a few.

In contrast, “current advertisements” may include advertisements that correspond to active advertising campaigns, and may correspond to products or services that are currently being offered to consumers or other similar advertising targets.

The present technology may utilize relational analyses of objects as a basis for providing advertisements. It will be understood that a relationship between a first object and one or more additional objects (e.g., connected entities) may be based upon one or more relatable characteristics, relationships, or connections shared therebetween. For example, the relationships between a musician and their discography, influences, etc., could relate the musician to other musicians, books, movies, and the like.

In addition, the present technology may be configured to correlate similar or different types of objects together based upon one or more relatable characteristics or relationships shared therebetween. The present technology may then trace a path(s) between the two or more objects and explain the relationships therebetween. For example, a musician may be indirectly related to a particular product based upon any one or more of a number of factors (e.g., a know relationship, explicit statements, and so forth). The systems provided herein may visually depict both the musician and the author utilizing image files, along with any intervening objects that connect the two objects together. Data that was utilized to connect the two objects together may also be provided to enhance the presentation of data to the end user. In other embodiments, the present technology may utilize a ribbon of images for each intervening object. These intervening images may be positioned between the images of the two objects to create a visual, diagrammatic path therebetween.

The present technology may then search the relational database(s) using the information for the object. The present technology may determine one or more additional objects within the relational database that are relevant or correlated to a first object. Objects may be either directly connected (e.g., only one connection away) or indirectly connected (e.g., greater than one connection away) together. Exemplary direct connections may include a musician and their discography.

It will be understood that a correlation or relationship between two or more objects may be determined from knowledge or information gathered regarding objects. Therefore, the greater the amount of information known about an object, the greater likelihood that a correlation (or multiple correlations) to another object may be determined. The types of knowledge or information regarding an object may include any type of descriptive information about the object. Information may be input into the system by scraping web content (e.g., web pages, crawling or searching third party databases, direct input from system administrators, or may even include information gathered via crowdsourcing where end users may contribute information or knowledge about objects).

To establish connections between objects in response to a query, the present technology may crawl a relational database to create a graph of objects and connections out to a defined radius around a first object. Advantageously, the present technology may gather these additional objects and sort them based on the rank of each object. For example, if the first object is connected to an additional object via numerous connections, the additional object may be ranked higher than other objects having fewer connections therebetween.

This collection of objects is then presented to the user in a visually apprehensible format, such as a graphical user interface that includes one or more graphs created from depictions of the objects.

According to some embodiments, the present technology may be configured to perform a method for correlating objects together in a database according to relational data. The present technology may be configured to, for each object in a database, determine a static weight, the static weight representing a number of relational connections between each object and one or more connected entities. Additionally, the present technology may be adapted to set a delta weight for each object, the delta weight being equal to the static weight.

In some instances, the present technology may determine which object in the database comprises a highest delta weight, and also propagate the highest delta weight of the object to each of the connected entities. In accordance with the present disclosure, the analysis module may add the highest delta weight to a static weight and a delta weight for each of the connected entities and set the delta weight for the object to zero.

It is noteworthy to mention that the method executed by the present technology may terminate the method upon determining that a highest delta weight for at least one object is below a threshold value.

According to some embodiments, the present technology may determine a relevancy for a direct or indirect connected entity based upon any of a static weight, distance, connection type, or any combinations thereof.

With regard to weighting, each object may be provided with at least one of a static weight and a dynamic weight. The present technology may associate a static weight with an object that includes a defined weight for each different connection type (e.g., connected entities associated with the object). According to some embodiments, each object starts with an initial static weight Wi, and delta weight dWi. In some instances, the static weight and the delta weight are substantially equal in magnitude to one another. Initially, the Wi and dWi of an object may be a non-zero value. The dWi value may be based on an amount and/or connection weight for each of the connected entities and other similar data.

In operation, the present technology may be configured to find a first object i that has largest dWi. The present technology may, for a first object, “shoot” or propagate a dWi to each connected entity j (e.g., additional objects that are directly connected to the object i). The present technology determines connected entities j by searching the relational database for directly connected objects. Thus, the present technology may iteratively locate an object in the database with the highest delta weight value and propagate the delta weight to each of the object's directly connected entities. Thus, after propagating the delta weight for an object having the highest delta weight in the database, the present technology may repeat the process by subsequently locating an additional object in the database with the highest delta weight. After dWi is applied to each connected object j, the present technology may set the dWi to zero. Again, it is noteworthy to mention that this process may be repeated for every object i in the graph (or database if the graph or matrix has not been created).

In some embodiments, the dWi for an object may be scaled by a connection rank for a connection between the object i and object j. This value may be referred to as the dWij. The dWij may be added to both the dWj and the Wj of a connected entity j such that the sum of Wj and dWij equal the Wj. Moreover, the sum of the dWj and the dWij may equal dWj.

According to some embodiments, the present technology may be configured to propagate the rank of each object i through the entire graph. For example, the present technology may iteratively propagate the rank of each object i to its direct or adjacent neighbors. It will be understood that the present technology may propagate the ranks of objects periodically or continually to allow for full propagation throughout the relational database.

Additional details regarding the processes for conducting relational analyses are described in greater detail with regard to U.S. Provisional patent application Ser. No. 13/544,980, filed on Jul. 9, 2012, entitled “SYSTEMS, METHODS, AND MEDIA FOR CORRELATING OBJECTS ACCORDING TO RELATIONSHIPS,” which is hereby incorporated by reference herein in its entirety including all references cited therein.

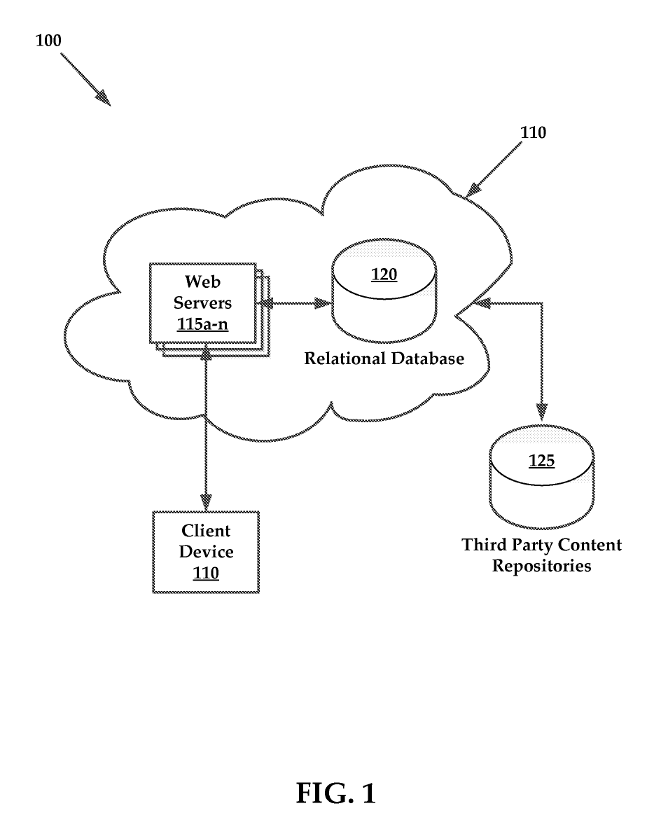

FIG. 1 illustrates an exemplary architecture 100 for practicing aspects of the present technology. Architecture 100 is shown as generally having a client device 105 that is communicatively couplable with a relational marketing system 110, hereinafter “system 110.” It will be understood that a plurality of client devices may communicatively couple with the system 110 via a private or public communications network such as the Internet.

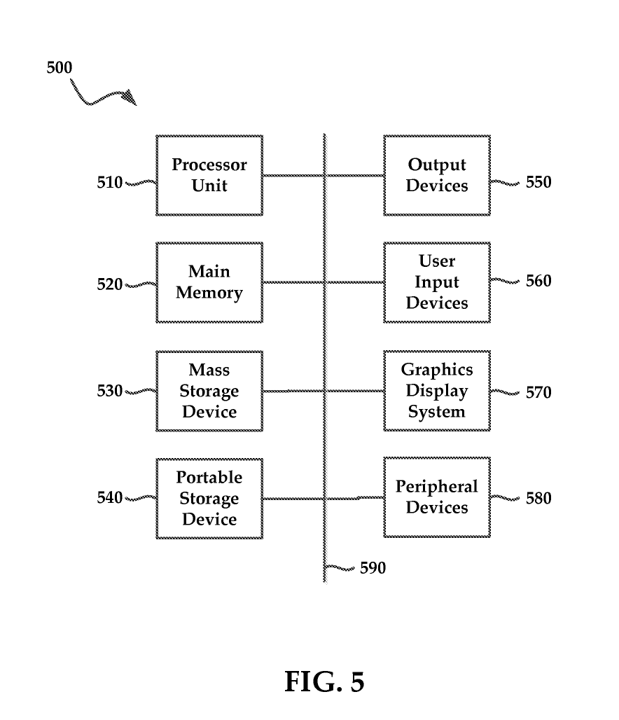

Generally speaking, the system 110 may include one or more web servers 115a-n and one or more relational databases, such as relational database 120. The servers 115a-n may each be generally described with reference to computing system 500, described in greater detail with reference to FIG. 5, although it will be understood that one or more of the servers 115a-n may include a particular purposes computing system configured to provide advertisements based upon relational data.

The system 110 may communicatively couple with a variety of third party content repositories 125. These content repositories 125 provide the system 110 with digital content that corresponds to correlated objects. Digital content may include textual content, images, audio files, and video files—just to name a few. For example, when exploring the relationships between a musician and their influences, image files for both the musician and their influences may be obtained by the system 110 from one or more content repositories.

Additionally, theses third party content repositories 125 may store and maintain advertisements that are provided to the system 110 upon request. Advertisements may include any interactive or non-interactive media such as web pages, banner advertisements, videos, hypervideos, audio, image files, and so forth. The system 110 may also be configured to combine a plurality of individual advertisements together to form a dynamic advertising campaign, as will be discussed in greater detail infra. In other embodiments, the system 110 may provide one or more current advertisements based upon the presentation of one or more legacy advertisements. In yet other embodiments, the system 110 may be configured to provide suggestive advertising based upon relation data linking one or more objects together.

According to some embodiments, the system 110 may communicatively couple with the third party content repositories 125 via an application programming interface (“API”). The API may utilize either secured or unsecured communications protocols for the transmission of data between the system 110 and the third party content repositories 125.

One of ordinary skill in the art will appreciate that the architecture 100 may include many other devices or systems (e.g., routers, firewalls, load balancers, and so forth) that allow for a plurality of client devices to interact with the system 110 or a plurality of content provider systems. A detailed discussion of these additional devices or systems has been omitted for the purpose of brevity.

In some embodiments, the system 110 may be configured a cloud computing environment. In general, a cloud-based computing environment is a resource that typically combines the computational power of a large grouping of processors (such as within servers 115a-n) and/or that combines the storage capacity of a large grouping of computer memories or storage devices (such as relational database 120). For example, systems that provide a cloud resource may be utilized exclusively by their owners, such as Google™ or Yahoo!™; or such systems may be accessible to outside users who deploy applications within the computing infrastructure to obtain the benefit of large computational or storage resources.

The cloud may be formed, for example, by a network of web servers such as web servers 115a-n with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

According to some embodiments, the system 110 may facilitate the use of a website or web-based interface that is accessible by the client device 105. Utilizing the website, end users may graphs associated with relation analyses, query for objects such as prospective purchases, view suggestive advertisements that correspond to the query—just to name a few. In other embodiments, the system 110 may be accessed via an executable application that resides on the client device 105, or within a cloud based computing environment.

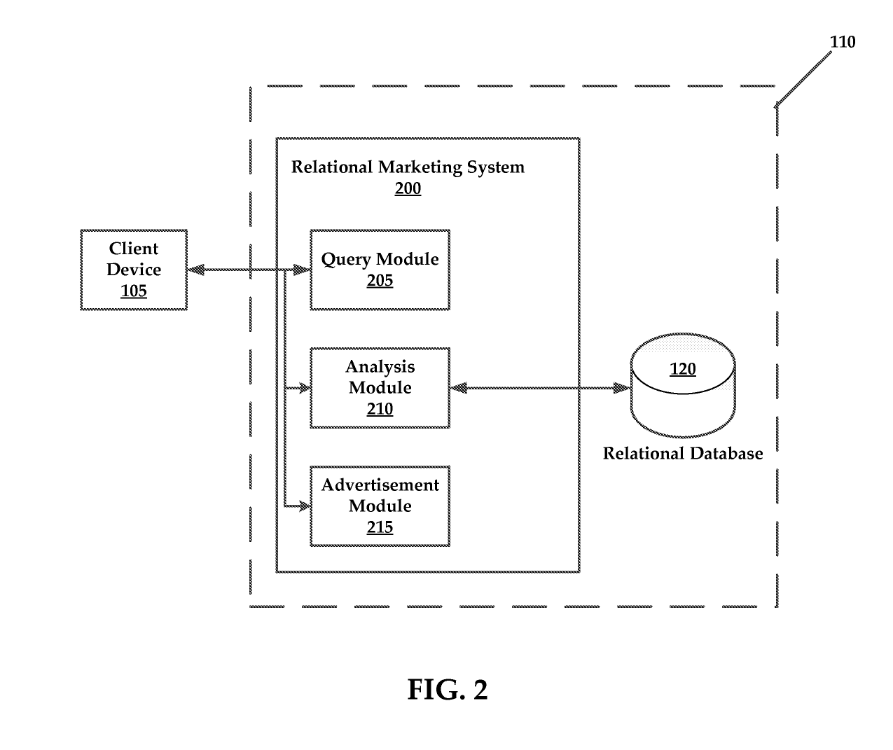

FIG. 2 illustrates an exemplary relational marketing system 200 that may reside with the system 110. The relational marketing system 200 may be generally described as being configured to provide advertisements based upon relational data such as connections between two or more objects.

Suggestive Advertisements

According to some embodiments, the relational marketing system 200 may provide creative or non-intuitive suggestive advertisements based upon data gathered from a query. For example, if an individual desires to purchase a creative or thoughtful product or service for a target consumer, the individual may query the relational marketing system 200 for products that are associated with one or more known interests of the target consumer. The individual may input any type of data such as a name of a favorite artist or a title of a film into a query.

As will be discussed below, because the relational marketing system 200 may utilize a long-tail response format that connects seemingly unrelated objects in a database, the relational marketing system 200 may be adept at providing non-intuitive product suggestions. In some instances, the header object may have a first domain type, such as a musician, while a second object (e.g., a connected entity) may have a different domain type, such as a book. For example, if the end user inputs the name of a musician, the relational marketing system 200 may create a long-tail format response that includes albums from the musician, as well as a book that inspired the musician for one of these selected albums. Each of the albums and the books would be a connected entity to the musician. Using the domain type differential, the relational marketing system 200 may select the book as a product suggestion. The relational marketing system 200 may obtain an advertisement or a link to the book that is then provided to the end user as a non-intuitive product suggestion. That is, a product suggestion may in some instances be an advertisement for a particular product and/or service.

The relational marketing system 200 may utilize indirect connections discovered via relational analysis that link the objects of the query (e.g., favorite artist) and other objects such as books, music, locations of interest, and so forth. Based upon known indirect (or even direct) connections, the relational marketing system 200 may select data that corresponds to each of the indirect connections such as images, album covers, audio files, and the like.

The relational marketing system 200 may arrange these objects into a graph or matrix and publish the graph to the web based interface or other display mechanism.

Upon selection of one or more of the indirectly correlated objects, the relational marketing system 200 may display the intermediate objects between the first object (object of the query) and the end point object (an object having an indirect connection). Because the relational marketing system 200 may provide visual depictions of intermediate objects, individuals may visually apprehend the relationship between the two objects. For example, an album by a particular band (first object) may be related to a film (indirectly related object) based upon the fact that a member of the band is related to the lead actor of the film.

It will be understood that the analysis module 210 may analyze multiple query objects and determine suggestive advertisements based upon weighting or ranking of connections between objects. For example, if the query includes a favorite musician and a favorite vacation destination, the analysis module 210 may provide suggestive advertising that includes ticket price data for a concert for the musician that is to occur at the vacation destination.

The analysis module 210 may process any number of objects and weigh the connections therebetween. As such, the analysis module 210 may not present suggestive advertisements for objects that have fewer connections to the first object. For example, the analysis module 210 may determine that a particular band local based in the vacation destination was influenced by the favorite musician. While the analysis module 210 may determine that these connections exist, the analysis module 210 may be configured to weight the “influenced by” connection less than a more direct connection of the vacation destination itself. Stated otherwise, the connection may be too indirectly related to the first object.

Objects having connections with relatively greater weight (e.g., numerous connections) relative to the other objects may be considered by the analysis module 210 to be more relevant with regard to the provision of suggestive advertising.

According to additional embodiments of the present technology, suggestive advertisements may be displayed via a web based graphical user interface generated by the advertising module 210. In some embodiments, the display of suggestive advertisements may include, but is not limited to, an image file of the product or service along with a hyperlink to the product or service provider's domain or contact data. In other embodiments, the system 200 may facilitate transactions concerning the products or services by allowing individuals to purchase the products or services that correspond to the suggestive advertisements by way of an e-commerce transaction facilitated by the system 200.

In some applications, the relational marketing system 200 may also provide a summary or narrative of the connections between the two objects such that the individual is provided with an explanation of how the two objects correspond to one another. Therefore, the relational marketing system 200 may provide individuals with a non-intuitive/thoughtful product or service that is highly relevant to the preferences of the target consumer.

According to some embodiments, the relational marketing system 200 may generally be described as including a query module 205, an analysis module 210, and an advertisement module 215. It is noteworthy that the relational marketing system 200 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the relational marketing system 200 may include separately configured web servers.

The query module 205 may receive queries for suggestive advertising. In some applications, the query module 205 may receive queries from a web interface that couples the client device 105 to the relational marketing system 200. Upon receipt of a query, the query module 205 may parse the query to determine objects included in the query. For example, the query module 205 may determine names, dates, locations, and the like, from a received query. The query module 205 may also utilize machine learning algorithms to improve efficiency and accuracy of system. For example, the query module 205 may utilize machine learning to determine that a query including the words “New” and “York” should be combined into “New York” rather than being understood by the system to be separate and unrelated words.

Each received query may be managed as a separate event and logged for further analysis. Moreover, web analytics may be gathered from the client device 105 each time a query is received therefrom.

The query module 205 may communicatively couple with the analysis module 210. That is, the query module 205 may communicate data that corresponds to objects that have been determined from a received query. For example, the query module 205 may communicate the string “David Bowie” to the analysis module 210, based upon receiving a query that includes the term “David Bowie.”

The analysis module 210 may then search the relational database 120 using the data for the object. The analysis module 210 may determine one or more additional objects within the relational database 120 that are relevant or correlated to a first object. As stated previously, objects may be either directly connected (e.g., only one connection away) or indirectly connected (e.g., greater than one connection away) together. Exemplary direct connections may include a musician and individual albums within their discography.

It will be understood that a correlation or relationship between two or more objects may be determined from knowledge or data gathered regarding objects. Therefore, the greater the amount of data known about an object, the greater likelihood that a correlation (or multiple correlations) to another object may be determined. The types of knowledge or data regarding an object may include any type of descriptive data about the object. Data may be input into the system by scraping web content (e.g., web pages, crawling or searching third party databases, direct input from system administrators, or may even include data gathered via crowdsourcing where end users may contribute data or knowledge about objects.

Utilizing known connections that are stored within the relational database 120, the analysis module 210 may cooperate with the advertising module 215 to obtain suggestive advertising. The analysis module 210 may obtain advertising from one or more of third party content repositories 125. These advertisements may be downloaded or streamed by the system 200 directly from one or more of the repositories.

According to some embodiments, the present technology may be directed to the generation of long-tail responses to queries. That is, rather than returning a single response to a query that includes a single object or multiple objects that are themselves unrelated to one another, the present technology may be configured to generate long-tail responses for queries. Thus, when generating a query response, the present technology begins with a header object, which is the object included in/determined from the query. To complete the response, additional objects are “attached” to the header object such that each successive object that is added to the response is related to the object which precedes it. Stated otherwise, each connected entity (except for the header object) is relationally connected with an immediately preceding connected entity Therefore, the response creates a “tail” of related objects that extend from the header object. The linkages that join the objects of the tail together are the known relationship values, which have been described in greater detail above.

These long-tail query responses may be utilized to create a long-tail response that includes a plurality of current and legacy advertisements relative to a header object. For example, if a query comprises a request for a particular artist, the analysis module 210 may set the artist as the header object. The advertising module 215 may search various databases for current and/or legacy advertisements that are related to the header object (e.g., the artist). For example, the artist may have endorsed a particular product in a legacy radio jingle for the product. The advertising module 215 may search databases for additional advertisements for that same product (either current or legacy).

In an additional exemplary embodiment, an end user may query for a product. Using the name of the product as the header object, the advertising module 215 may search various databases for current and/or legacy advertisements associated with the product. Using advertisement age as a linkage, the advertising module 215 may join the advertisements together in a long-tail format to assemble the advertisements into a timeline of advertisements. The timeline may be displayed to the end user such that clicking any of the advertisements on the timeline causes the advertisement to be displayed to the end user.

Legacy/Current Advertisements

The advertising module 215 may obtain advertisements by searching the third party content repositories 125 for data, metadata, tags, or other indicative data that links an object to an advertisement. For example, a musician may be connected to a video advertisement for a product because the musician was featured in the video advertisement. As such the video advertisement may be tagged with the name of the musician for ease in searching and retrieval via search query. Interrelating advertisements to subject matter would be well within the knowledge of one of ordinary skill in the art. Therefore, a detailed discussion of these methods or processes has been omitted for the purposes of brevity.

It will be understood that if the video advertisement includes a legacy advertisement, the advertising module 215 may obtain one or more current advertisements that are to be presented along with the legacy advertisement. The current advertisement may include a relevant advertisement for the same product, or may include a current advertisement for an alternative product produced by the same product or service provider.

The advertising module 215 may also be configured to log each request for a current advertisement, and each successful presentation of a current advertisement for proper apportionment of advertising revenue. These events may be maintained within the system 200 as individual records for each advertiser.

Advantageously, legacy advertisements accessed within the context of a relational analysis may provide the basis for creating value from legacy advertisements that may no longer be relevant to the greater public. For example, an individual who views a legacy video advertisement for a product based upon the fact that the legacy advertisement includes a favorite musician, may now be provided with a current advertisement from the same product provider for the same or even a different product. While this legacy advertisement may no longer be relevant to the greater public, the individual's interest in the musician serves as a basis for extending the life of the legacy advertisement.

Dynamically Rotating Advertising Content

In some applications, the system 200 may utilize a rotating advertisement schema or campaign that substantially reduces advertisement fatigue. For example, the system 200 may utilize a central advertising theme that includes the promotion of a movie. Rather than presenting a video trailer for the movie each time a targeted customer visits a website, the system 200 may obtain a plurality of advertisements associated with the promotion of the movie, such as interviews with the actors, soundtrack advertisements, posters, and the like. Utilizing the plurality of advertisements, the system 200 may establish a central advertising object that is presented for a predetermined amount of time. One or more of the additional or supporting advertisements may be disposed proximately around the central advertising object.

Over time the system 200 may replace the central advertising object with one of the additional advertising objects and move the central advertising object to a supporting position. The system 200 may selectively replace the central advertising object according to a predetermine schedule, or may configure to replace the central advertising object based upon web analytics such as repeated page views from the same Internet protocol address within a given period of time.

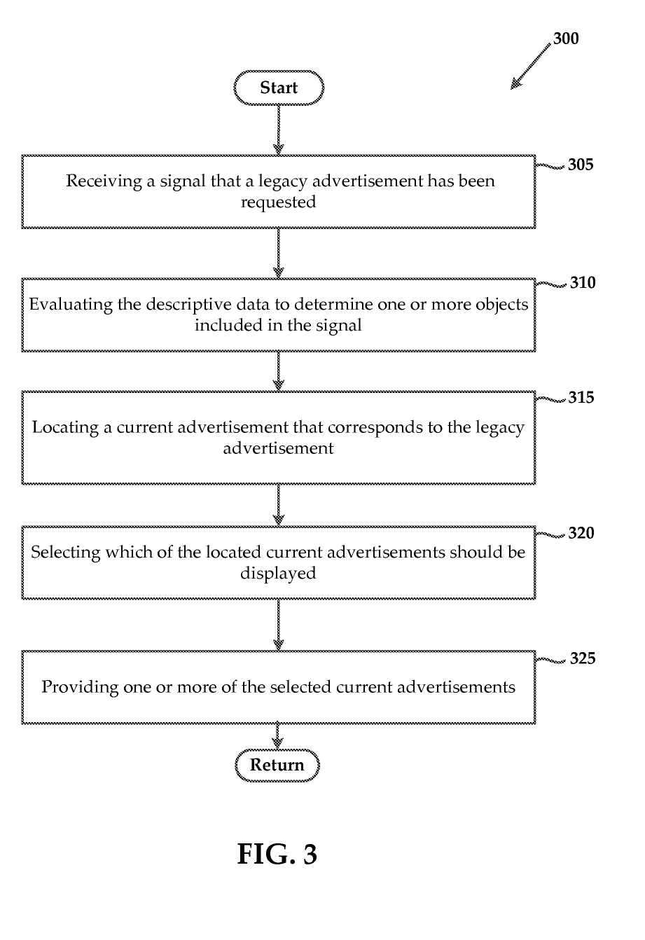

FIG. 3 is a flowchart of an exemplary method 300 for providing current advertisements based upon the provision of a legacy advertisement. The method may include the step 305 of receiving data (e.g., a signal) that a legacy advertisement has been requested. This request may include an individual clicking or otherwise accessing the legacy advertisement. The accessing of the legacy advertisement may generate a signal that is provided to the analysis module of the relational marketing system. According to some embodiments, the signal may include descriptive data such as the creation date, original run date (when the advertisement was utilized), subject matter, metadata, tags, and so forth.

Upon receiving a signal, the method may include the step 310 of evaluating the descriptive data to determine one or more objects included in the signal. Objects may include any of names, locations, dates, and events—just to name a few.

Next, the method may include a step 315 of locating a current advertisement that corresponds to the legacy advertisement. This step 315 may include querying local or remote (e.g., third party) databases utilizing the evaluated data included in the signal to locate one or more current advertisements.

If two or more current advertisements are located, the method 300 may also include a step 320 of selecting which of the located current advertisements should be displayed. The selection of advertisements may be based upon relevance or preferences of the individual (may be based upon web analytics), or may be based upon the subject matter of the legacy advertisement.

Finally, the method may include a step 325 of providing one or more of the selected current advertisements. This step may include publishing the advertisements to a web based interface or providing the advertisements via an application or direct communication utilizing various communication protocols such as short message system (“SMS”), electronic mail, and so forth.

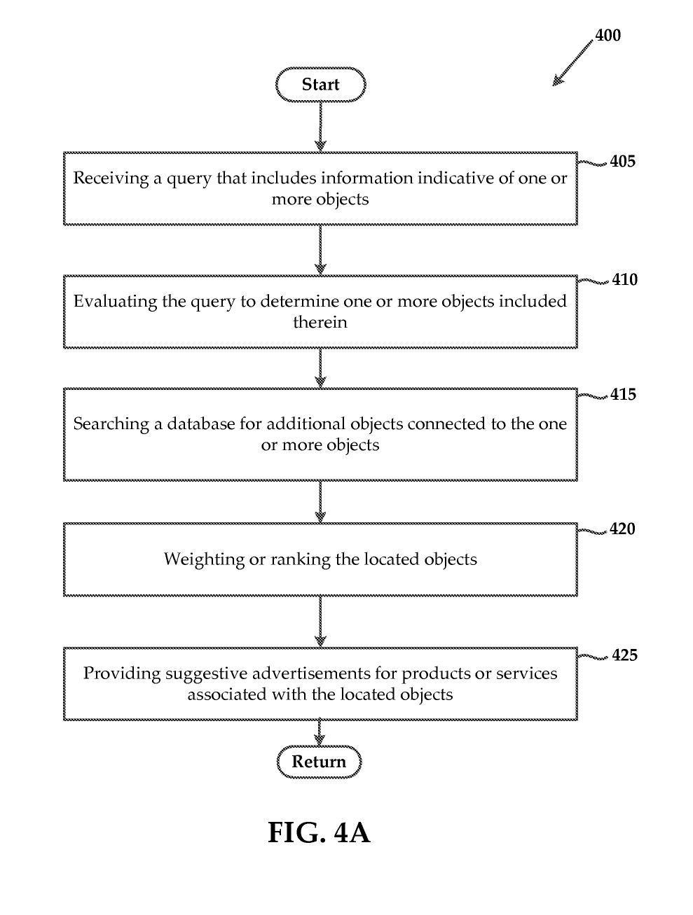

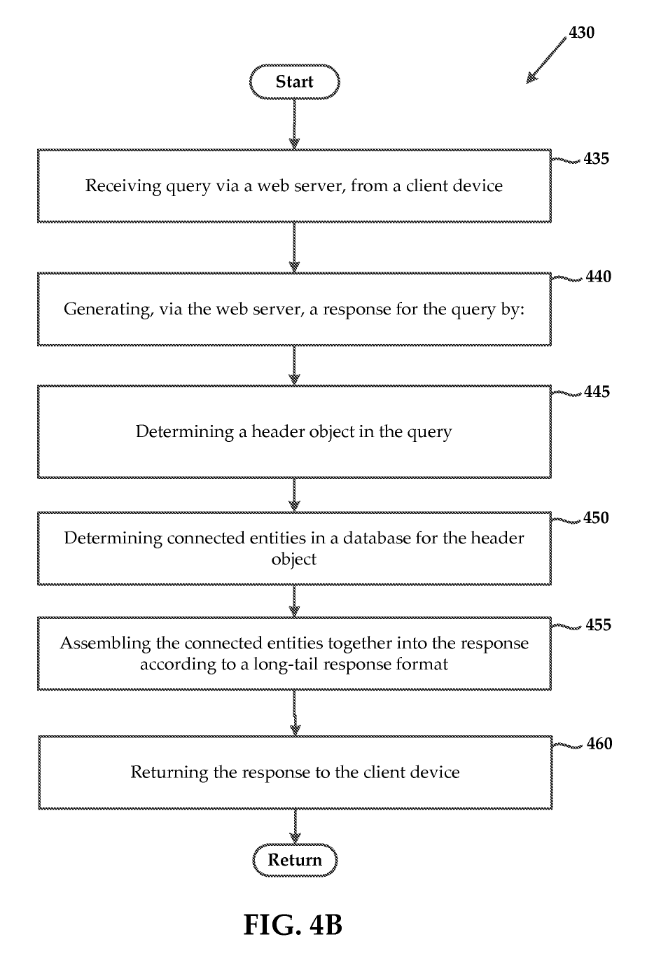

FIG. 4A is a flowchart of an exemplary method 400 for providing selective advertisements based upon relational data. The method 400 may begin with a step 405 of receiving a query that includes information indicative of one or more objects. Responsive to receiving the query, the method 410 may include the step 410 of evaluating the query to determine one or more objects included therein.

In some embodiments, the method may also include a step of receiving a plurality of responses to question provided to the individual, rather than (or in addition to) utilizing only information gathered from the query. In this way, additional preference data may be obtained to enhance the selection of appropriate suggestive advertising.

Upon determining one or more objects, the method may include the step 415 of searching a database for additional objects connected to the one or more objects. It will be understood that the connections between these additional objects and the one or more objects of the query may be previously determined via relational analyses.

Assuming one or more additional objects were located by searching the database, the method may include the step 420 of weighting or ranking the located objects based upon any of a number of factors such as connection number, connection type, and the like.

Next, the method may include providing suggestive advertisements for products or services associated with the located objects in step 425, in response to receiving a query. Therefore, the selection of suggestive advertisements may be based upon indirect information that ties the objects of the query to one or more additional objects. For example, the system may provide suggestive advertisements for donations to nonprofit organizations based upon information such as celebrity endorsements. Because the individual has an expressed interested in numerous celebrities that have endorsed the same nonprofit agency, a suggestive advertisement for donating to a particular nonprofit agency may be presented.

FIG. 4B a flowchart of another exemplary method 430 for providing selective advertisements based upon relational data. The method may comprise a step 435 of receiving query via a web server, from a client device. The method may also include a step 440 of generating, via the web server, a response for the query by executing a sub-step 445 of determining a header object in the query. The step 440 may also comprise a sub-step 450 of determining connected entities in a database for the header object, along with a sub-step 455 of assembling the connected entities together into the response according to a long-tail response format. Additionally, the method may comprise a step 460 of returning the response to the client device.

FIG. 5 illustrates an exemplary computing system 500 that may be used to implement an embodiment of the present technology. The computing system 500 of FIG. 5 includes one or more processors 510 and main memory 520. Main memory 520 stores, in part, instructions and data for execution by processor 510. Main memory 520 can store the executable code when the system 500 is in operation. The system 500 of FIG. 5 may further include a mass storage device 530, portable storage devices 540, output devices 550, user input devices 560, a graphics display 570, and other peripheral devices 580.

The components shown in FIG. 5 are depicted as being connected via a single bus 590. The components may be connected through one or more data transport means. Processor unit 510 and main memory 520 may be connected via a local microprocessor bus, and the mass storage device 530, peripheral device(s) 580, portable storage device(s) 540, and graphics display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present technology for purposes of loading that software into main memory 520.

Portable storage device 540 operates in conjunction with a portable non-volatile storage media, such as a floppy disk, compact disk or digital video disc, to input and output data and code to and from the computer system 500 of FIG. 5. The system software for implementing embodiments of the present technology may be stored on such a portable media and input to the computer system 500 via the portable storage device 540.

User input devices 560 provide a portion of a user interface. User input devices 560 may include an alphanumeric keypad, such as a keyboard, for inputting alphanumeric and other data, or a pointing device, such as a mouse, a trackball, stylus, or cursor direction keys. Additionally, the system 500 as shown in FIG. 5 includes output devices 550. Suitable output devices include speakers, printers, network interfaces, and monitors.

Graphics display system 570 may include a liquid crystal display (LCD) or other suitable display device. Graphics display system 570 receives textual and graphical data, and processes the data for output to the display device.

Peripheral devices 580 may include any type of computer support device to add additional functionality to the computer system. Peripheral device(s) 580 may include a modem or a router.

The components contained in the computer system 500 of FIG. 5 are those typically found in computer systems that may be suitable for use with embodiments of the present technology and are intended to represent a broad category of such computer components that are well known in the art. Thus, the computer system 500 of FIG. 5 can be a personal computer, hand held computing system, telephone, mobile computing system, workstation, server, minicomputer, mainframe computer, or any other computing system. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable media). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage media” and “computer-readable storage media” as used herein refer to any media or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic media, a CD-ROM disk, digital video disk (DVD), any other optical media, any other physical media with patterns of marks or holes, a RAM, a PROM, an EPROM, an EEPROM, a FLASHEPROM, any other memory chip or data exchange adapter, a carrier wave, or any other media from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the technology will become apparent to those of skill in the art upon review of this disclosure. The scope of the technology should, therefore, be determined not with reference to the above description.

What is claimed is:

1. A method for processing a query, the method comprising:
receiving query via a web server, from a client device;
generating, via the web server, a response for the query by:
determining a header object in the query;
determining connected entities in a database for the header object; and
assembling the connected entities together into the response according to a long-tail response format; and
returning the response to the client device.

2. The method according to claim 1, wherein the long-tail response format begins with the header object, wherein each subsequent connected entity is relationally connected with an immediately preceding connected entity.

3. The method according to claim 1, wherein at least one of the connected entities comprises an advertisement.

4. The method according to claim 1, wherein at least one of the header object and the connected entities comprises a current advertisement and at least one of the header object and the connected entities comprises a legacy advertisement.

5. The method according to claim 1, wherein the response comprises an image file for the header object and each of the connected entities, wherein the image files are assembled together according to the long-tail response format.

6. The method according to claim 1, further comprising returning a product suggestion that corresponds to at least one of the connected entities in the response.

7. The method according to claim 6, wherein the product suggestion has a different domain type than the domain type of the header object.

8. A method for providing advertisements based upon relational data, the method comprising:
receiving query via a web server, from a client device;
generating, via the web server, a response for the query by:
determining a header object in the query;
locating a first advertisement associated with the header object; and
locating a legacy advertisement if the first advertisement is a current advertisement or a current advertisement if the first advertisement is a legacy advertisement; and
returning the response to the client device.

9. The method according to claim 8, further comprising returning the first advertisement and the legacy or the current advertisement in a timeline format.

10. The method according to claim 9, wherein the timeline format begins with the first advertisement, wherein the legacy advertisement or the current advertisement are linked with the first advertisement according to an advertisement age.

11. A system for processing a query, the system comprising:
at least one server that is selectively coupleable to a client device, the at least one server comprising a processor configured to execute instructions that comprise:
a query module that receives query from a client device; and
an analysis module that generates a response for the query by:
determining a header object in the query;
determining connected entities in a database for the header object;
assembling the connected entities together into the response according to a long-tail response format; and
returning the response to the client device.

12. The system according to claim 11, wherein the long-tail response format begins with the header object, wherein each subsequent connected entity is relationally connected with an immediately preceding connected entity.

13. The system according to claim 11, wherein at least one of the connected entities comprises an advertisement located by an advertisement module.

14. The system according to claim 11, wherein at least one of the header object and the connected entities comprises a current advertisement and at least one of the header object and the connected entities comprises a legacy advertisement.

15. The system according to claim 11, wherein the response comprises an image file for the header object and each of the connected entities, wherein the image files are assembled together according to the long-tail response format.

16. The system according to claim 11, further comprising an advertisement module that returns a product suggestion to the client device that corresponds to at least one of the connected entities in the response.

17. The system according to claim 16, wherein the product suggestion has a different domain type than the domain type of the header object.

18. The system according to claim 11, further comprising an advertisement module that:
locates a first advertisement associated with the header object; and
locates a legacy advertisement if the first advertisement is a current advertisement or a current advertisement if the first advertisement is a legacy advertisement.

19. The system according to claim 18, wherein the advertisement module returns the first advertisement and the legacy or the current advertisement in a timeline format.
